(19) United States
(12) Patent Application Publication
(10) Pub. No.: US 2010/0271444 A1
(43) Pub. Date: Oct. 28, 2010

(54) INK CARTRIDGE, ESPECIALLY FOR AN INK JET PRINTER

(75) Inventor: Daniel Sulser, Wald (CH)

Correspondence Address: MICHAEL BEST & FRIEDRICH LLP, 100 E WISCONSIN AVENUE, Suite 3300, MILWAUKEE, WI, 53202, US

(73) Assignee: PELIKAN HARDCOPY PRODUCTION AG, Egg (CH)

(21) Appl. No.: 12/743,737

(22) PCT Filed: Nov. 18, 2008
(86) PCT No.: PCT/EP08/65722

§ 371 Date: May 19, 2010

(30) Foreign Application Priority Data
Nov. 19, 2007 (DE) 102007055161.6

(51) Int. Cl. B41J 2/175

(52) U.S. Cl. 347/86

(57) ABSTRACT

An ink cartridge (10) having an ink reservoir which delimits in a first chamber (17) a free-ink volume (16) and in a second chamber (18) a capillary volume (15), there being an ink outlet (21) associated with the latter, and wherein for use of the cartridge both chambers (17, 18) are connectible to the external environment by way of air-admission openings (23, 24) which prior to use are closed by a removable or peelable film or so-called remove film (25). The air-admission openings (23, 24) are arranged with respect to one another in such a way that when the remove film (25) is peeled off it is always the chamber (18) delimiting the capillary volume (15) to which air is admitted first.

### RELATED APPLICATION DATA

This application claims priority from German Patent Application No. 10 2007 055 161.6, filed Nov. 19, 2007 and PCT Application No. PCT/EP2008/065722, filed Nov. 18, 2008, both of which are incorporated by reference herein.

### BACKGROUND

The present invention relates to an ink cartridge, especially an ink cartridge for an inkjet printer, having an ink reservoir which delimits in a first chamber a free-ink volume and in a second a capillary volume, there being an ink outlet associated with the latter, and wherein for use of the cartridge both chambers are connectible to the external environment by way of air-admission openings which prior to use are closed by a removable or peelable film or so-called “remove film”.

Two-chamber ink cartridges of that kind are generally known. One chamber is filled with liquid ink and the other with an ink storage element, for example a sponge or the like. There is a fluidic connection between the two chambers, so that the storage element always makes sufficient ink available to an ink outlet associated therewith and that is the case until substantially all of the ink has been used. In use, the two chambers must be connected to the external environment in order to ensure pressure equalization inside the ink cartridge on withdrawal of ink through the ink outlet. It is, of course, necessary to close the air-admission openings in question after the ink cartridge has been filled. This is conventionally done with a so-called remove film. Such a remove film is peeled off prior to use, it being very important, however, that the admission of air into the two chambers takes place in the correct order, because in the event of incorrect handling the pressure equalization between the two chambers and the environment that occurs on opening of the air-admission openings will result in unexpected splashes of ink.

That problem has been solved hitherto by a remove film which extends over the two air-admission openings respectively associated with the two afore-mentioned chambers of the ink cartridge, those air-admission openings generally being constructed one behind the other in the top wall of the ink cartridge, and on which an arrow is printed indicating the peel-off direction of the remove film. When that peel-off direction is observed, first the air-admission opening associated with the storage chamber and then the air-admission opening associated with the free-ink chamber is unblocked. The pressure equalisation between the two chambers on the one hand and the external environment on the other hand thus takes place initially by way of the storage chamber, that is to say the chamber delimiting the so-called capillary volume. By virtue of the storage element in that chamber, when pressure equalization is established an unexpected escape of ink through the air-admission opening associated with the storage chamber is prevented. A disadvantage, however, is that if the peel-off direction of the remove film is not observed, air is admitted to the free-ink chamber first, with the result that ink can escape unexpectedly through the air-admission opening in question.

### SUMMARY

The present invention is therefore based on the problem of providing an ink cartridge of the kind mentioned at the beginning in which unexpected splashes of ink before use are reliably avoided.

An important concept of the present invention therefore lies in the fact that the air-admission openings, which are associated with the free-ink volume on the one hand and the capillary volume on the other hand, are arranged with respect to one another in such a way that when the remove film is peeled off it is always the chamber of the ink cartridge delimiting the capillary volume to which air is admitted first. The user therefore no longer needs to take care to peel off the remove film in accordance with a printed arrow or similar instruction. According to the invention, therefore, the objective is to ensure that, irrespective of the peel-off direction, air is always admitted first to the chamber delimiting the capillary volume.

If the remove film allows only a certain or preferred peel-off direction, the air-admission openings should be constructed and arranged in such a way that the air-admission opening associated with the free-ink volume is arranged between two air-admission openings associated with the capillary volume, since it is then immaterial whether the remove film is peeled off from left to right or from right to left in the preferred peel-off direction prior to use of the ink cartridge.

In order to ensure that at all events air is admitted to the chamber delimiting the capillary volume before the chamber delimiting the free-ink volume, irrespective of the peel-off direction of the remove film, the air-admission openings are preferably arranged one inside the other, forming an inner air-admission opening associated with the free-ink volume and an outer air-admission opening which surrounds the inner air-admission opening in the shape of a ring and is associated with the capillary volume. In that case, it is ensured that the chamber associated with the capillary volume is always opened first for the purpose of pressure equalization. Only then is the admission of air to the chamber delimiting the free-ink volume effected. An unexpected escape of ink from the latter caused by the establishment of pressure equalization when the remove film is removed is then reliably excluded.

An especially simple embodiment, both in respect of handling and in respect of manufacture, is characterized in that the air-admission openings and the ink outlet are both closable by the remove film. In that case only a single remove film is required for all of those openings. In the case of this particular embodiment, the construction and arrangement of the air-admission openings in accordance with the invention is of great importance, because it is then immaterial whether the remove film is peeled off starting from the air-admission openings or starting from the ink outlet. In each case it is ensured that air is admitted first to the chamber delimiting the capillary volume.

A preferred embodiment of an ink cartridge comprises four side walls, a base wall and a top wall, the ink outlet being arranged either in the base wall or close to the base in a side wall. The air-admission openings are arranged in the top wall, preferably as short a distance away as possible from the ink outlet, that is to say as close as possible to the side wall in which the ink outlet is located or which adjoins the side of the base wall in which the ink outlet is located.

An embodiment of an ink cartridge constructed in accordance with the invention is described in greater detail below with reference to the accompanying drawing.

### BRIEF DESCRIPTION OF THE DRAWINGS

FIG. 1 shows an ink cartridge constructed in accordance with the invention in a perspective view, obliquely from above; and

FIG. 2 shows the ink cartridge according to FIG. 1 in longitudinal section.

### DETAILED DESCRIPTION

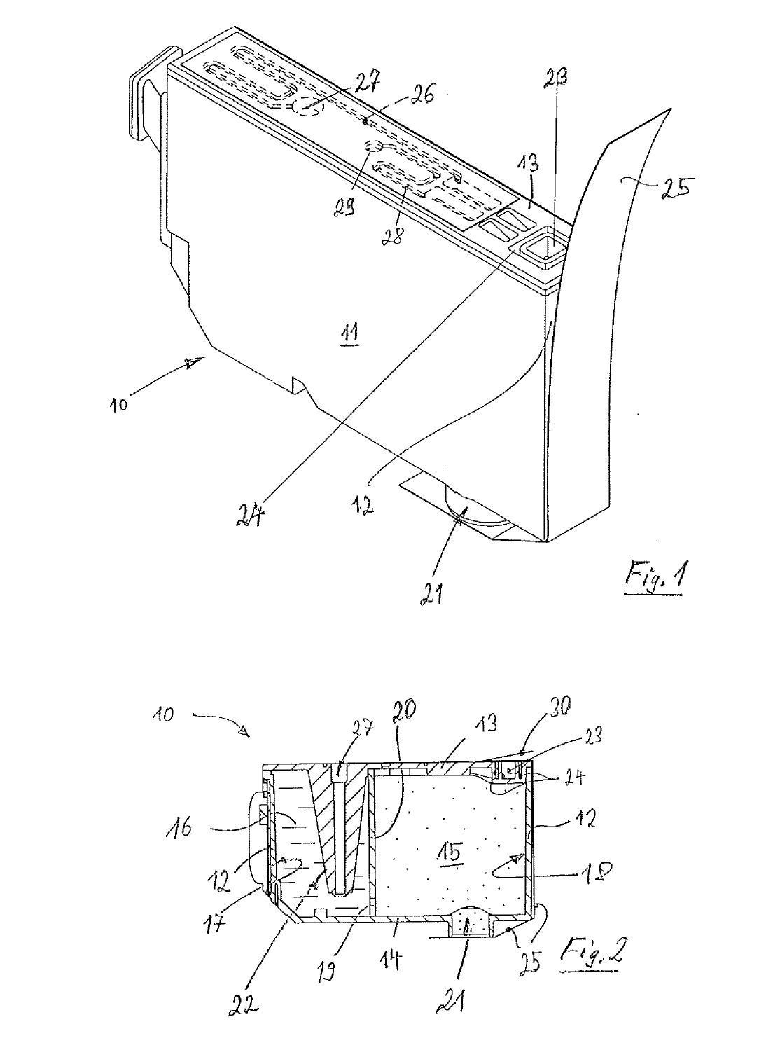

The ink cartridge shown diagrammatically in FIGS. 1 and 2 is indicated by reference numeral 10. This ink cartridge comprises four side walls, more specifically two flat side walls 11 located opposite one another and two end side walls 12 located opposite one another, as well as a top wall 13 and a base wall 14. The top wall 13 is formed by a separate top which, after an ink storage element defining a capillary volume 15 has been mounted inside the ink cartridge, is adhesively bonded or welded to the upper edges of the side walls of the ink cartridge. The ink storage element defining the capillary volume 15 can consist of open-pored foam material or fibre material, this being a measure known per se which need not be described in detail herein. The chamber 18 delimiting the afore-mentioned capillary volume is in fluidic connection with a further chamber 17 by way of a passageway 19 close to the base, the chamber 17 delimiting a so-called free-ink volume 16. That chamber 17 therefore contains liquid ink. The two chambers 17 and 18 are separated from one another inside the cartridge by an intermediate wall 20, the afore-mentioned fluid passageway 19 being located at the lower end, that is to say the end close to the base, of the intermediate wall 20. By way of that fluid passageway 19, the capillary volume 15 is supplied with ink from the chamber 17. An ink outlet 21, associated with the capillary volume 15, is provided in the base wall 14. By way of that ink outlet, ink is supplied from the cartridge to a print head of an inkjet printer.

Starting from the top wall 13, a so-called bubble generator, which is indicated by reference numeral 22 in FIG. 2, projects into the chamber 17.

Hereinbelow, the chamber 17 is referred to as the first chamber and the chamber 18 as the second chamber.

Associated with both chambers 17, 18 are air-admission openings 23, 24 by way of which a connection can be made to the external environment for use of the cartridge 10. It is thus possible to establish pressure equalization between the two chambers on the one hand and with the environment on the other hand, so that the supply of ink through the ink outlet 21 is ensured. Prior to use, the two air-admission openings are closed by a removable or peelable film or so-called remove film 25. In the embodiment shown (see FIG. 1) the two air-admission openings 23, 24 are arranged one inside the other, forming an inner air-admission opening 23 associated with the free-ink volume 16, i.e. the first chamber 17, and an outer air-admission opening 24 which surrounds the inner air-admission opening 23 in the shape of a ring and is associated with the capillary volume 15, i.e. the second chamber 18. When the remove film 25 is peeled off, for example in accordance with FIG. 1, it is thus ensured that it is always the air-admission opening 24 associated with the capillary volume 15 that is unblocked first. Accordingly, air is admitted first to the second chamber 18 delimiting the capillary volume 15. Only then does the admission of air to the chamber 17 delimiting the free-ink volume 16 take place. Ink can no longer splash out from that opening unexpectedly, because pressure equalization has already taken place by way of the opening 23.

In the embodiment shown, the air-admission openings 23, 24 and the ink outlet 21 are both closed by the remove film 25. In that respect the remove film fulfils a kind of double function.

The air-admission openings 23, 24 are, as already mentioned, arranged in the top wall 13; in the embodiment shown they are located approximately opposite the ink outlet 21.

The openings 23, 24 are, of course, connected to the two afore-mentioned chambers 17, 18 by way of channels formed in the top wall 13. Those channels are shown by dotted lines in FIG. 1. The air-admission opening 23 is connected to the first chamber 17 by way of a first channel 26 and an opening 27 which leads into the first chamber 17, while the air-admission opening 24 is connected to the second chamber 18 by way of a second channel 28 and an opening 29 which leads into the second chamber.

The afore-mentioned opening 27 is otherwise part of the afore-mentioned bubble generator by means of which the pressure equalization in the first chamber 17 delimiting the free-ink volume 16 is effected, the air flowing in from the outside being introduced into the first chamber 17 bubblewise by way of the bubble generator 22, the corresponding opening at the lower end of the bubble generator 22 being of slot-like construction and being so small that air bubbles can enter the free-ink but free-ink does not readily penetrate to the outside.

The remove film 25 is also folded backwards above the air-admission openings 23, 24 in order to define a corresponding grip tab 30. Accordingly, the user is able to grasp the remove film initially by the afore-mentioned grip tab and to peel it off starting from that location, simultaneously opening the air-admission openings 23, 24 in the way described above. That is followed by the opening of the ink outlet 21. It is equally conceivable, however, to peel off the remove film 25 starting from the ink outlet 21, beyond which it indeed projects slightly.

All the features disclosed in the application documents are claimed as being important to the invention to the extent that they are novel individually or with respect to the prior art.

1.-5. (canceled)

6. An ink cartridge configured for use with an inkjet printer, the ink cartridge comprising:
an ink reservoir which delimits in a first chamber (17) a free-ink volume (16) and in a second chamber (18) a capillary volume (15); and
an ink outlet (21) associated with the capillary volume,
wherein for use of the cartridge both the first and the second chambers (17, 18) are connectible to an external environment by way of air-admission openings (23, 24) which prior to use are closed by a remove film (25), and
wherein the air-admission openings (23, 24) are arranged with respect to one another in such a way that when the remove film (25) is peeled off the air-admission openings it is always the second chamber (18) delimiting the capillary volume (15) to which air is admitted first.

7. The ink cartridge according to claim 6, wherein the air-admission openings (23, 24) are constructed and arranged in a preferred peel-off direction in such a way that an air-admission opening associated with the free-ink volume (16) is arranged between two air-admission openings associated with the capillary volume (15).

8. The ink cartridge according to claim 6, wherein the air-admission openings (23, 24) are arranged one inside the other, forming an inner air-admission opening (23) associated with the free-ink volume (16) and an outer air-admission opening (24) which surrounds the inner air-admission opening (23) in the shape of a ring and is associated with the capillary volume (15).

9. The ink cartridge according to claim 7, wherein the air-admission openings (23, 24) are arranged one inside the other, forming an inner air-admission opening (23) associated with the free-ink volume (16) and an outer air-admission opening (24) which surrounds the inner air-admission opening (23) in the shape of a ring and is associated with the capillary volume (15).

10. The ink cartridge according to claim 6, wherein the air-admission openings (23, 24) and the ink outlet (21) are both closable by the remove film (25).

11. The ink cartridge according to claim 7, wherein the air-admission openings (23, 24) and the ink outlet (21) are both closable by the remove film (25).

12. The ink cartridge according to claim 8, wherein the air-admission openings (23, 24) and the ink outlet (21) are both closable by the remove film (25).

13. The ink cartridge according to claims 6, further comprising
four side walls (11, 12);
a base wall (14); and
a top wall (13),
wherein the ink outlet (21) is arranged in one of the base wall (14) and close to the base wall in one of the side walls,
wherein the air-admission openings (23, 24) are arranged in the top wall (13), and
wherein the air admission openings are as short a distance away as possible from the ink outlet (21).

14. The ink cartridge according to claim 7, further comprising
four side walls (11, 12);
a base wall (14); and
a top wall (13),
wherein the ink outlet (21) is arranged in one of the base wall (14) and close to the base wall in one of the side walls,
wherein the air-admission openings (23, 24) are arranged in the top wall (13), and
wherein the air admission openings are as short a distance away as possible from the ink outlet (21).

15. The ink cartridge according to claim 8, further comprising
four side walls (11, 12);
a base wall (14); and
a top wall (13),
wherein the ink outlet (21) is arranged in one of the base wall (14) and close to the base wall in one of the side walls,
wherein the air-admission openings (23, 24) are arranged in the top wall (13), and
wherein the air admission openings are as short a distance away as possible from the ink outlet (21).

16. The ink cartridge according to claim 10, further comprising
four side walls (11, 12);
a base wall (14); and
a top wall (13),
wherein the ink outlet (21) is arranged in one of the base wall (14) and close to the base wall in one of the side walls,
wherein the air-admission openings (23, 24) are arranged in the top wall (13), and
wherein the air admission openings are as short a distance away as possible from the ink outlet (21).
